(19) United States
(12) Patent Application Publication
(10) Pub. No.: US 2004/0002047 A1
(43) Pub. Date: Jan. 1, 2004

(54) System and method for developing critical thinking

(75) Inventors: Roger H. Bruning, Lincoln, NE (US); Christy A. Horn, Lincoln, NE (US)

Correspondence Address: Christopher J. Eaton, SHOOK, HARDY & BACON L.L.P., One Kansas City Place, 1200 Main Street, Kansas City, MO, 64105-2118, US

(73) Assignee: BOARD OF REGENTS OF UNIVERSITY OF NEBRASKA

(21) Appl. No.: 10/607,730

(22) Filed: Jun. 27, 2003

Related U.S. Application Data
(60) Provisional application No. 60/392,563, filed on Jun. 28, 2002.

(51) Int. Cl. G09B 3/00; G09B 7/00

(52) U.S. Cl. 434/322

(57) ABSTRACT

The systems and methods of the present invention teach critical thinking skills in a computer-based environment, and particularly in a computer network-based environment. In one embodiment, the present invention is a method in which information and a question are presented to a learner and the learner is asked to answer the question and justify his or her answer. The learner may view reference material, which may include information provided by a “coach,” to assist in answering the question and justifying his or her answer. After providing an answer and a justification, an analysis is performed generating at least one result. Thereafter, the at least one result is provided to the learner along with an expert's answer and justification. The learner may then review other learners' answers and justifications and otherwise interact with other answers and justifications, such as by selecting the best justifications, rating the justifications, and e-mailing comments to other learners.

### CROSS-REFERENCE TO RELATED APPLICATIONS

This application claims priority pursuant to 35 U.S.C. Section 119 from U.S. Provisional Application No. 60/392,563 filed Jun. 28, 2002.

### STATEMENT REGARDING FEDERALLY SPONSORED RESEARCH OR DEVELOPMENT

None.

### BACKGROUND OF THE INVENTION

The present invention provides a computer-based method of and system for teaching thinking skills. More particularly, the present invention provides a method and system in which a learner is taught to think critically about content presented in a computing environment.

Increasingly, teachers and others are using individual and networked computers to present information to students and other learners and to question, quiz or test the learners about the information. Unfortunately, the present systems and methods do not seek to develop critical thinking skills in addition to or in conjunction with teaching a particular subject matter. Instead, the present systems and methods are satisfied with rote memorization.

Critical thinking skills have been said to include interpretation, analysis, evaluation, inference, explanation, and self-regulation. Clearly, these skills go beyond merely viewing and then memorizing information. More specifically, critical thinking makes it possible for a learner to do more than merely answer a question; critical thinking allows a learner to provide some rationale or justification for his or her answer. Thus, to teach a learner to think critically, a system and method of teaching must require that the learner provide some justification for his or her answer and then provide information so that the learner may critique his or her answers and justifications. The present invention accomplishes this and other objectives.

### BRIEF SUMMARY OF THE INVENTION

The present invention encompasses a computer-based system and method for teaching critical thinking skills. In one embodiment, the present invention is a method in which information and a question are presented to a learner and the learner is asked to answer the question and justify his or her answer. The learner may view reference material to assist in answering the question and justifying his or her answer. After providing an answer and a justification, a statistical analysis is performed. Thereafter, a number of results are provided to the learner. These results may include not only the outcome of the analysis, but also other learners' answers and justifications. The learner may then review an expert's opinion regarding an acceptable answer and justification. Also, after receiving the results, the learner may interact with other learners' answers and justifications, such as by selecting the best justifications, rating the justifications, and e-mailing comments to other learners.

In another embodiment, the present invention is a computer-based system that includes modules that are operable to receive and store informational content and questions and to provide the information and questions to learners. The system also includes a coach module, a resource module and an expert module that are operable to store reference material and to provide that material to learners. The system further includes an analysis module that is operable to perform statistical analysis and provide results, such as charts and graphs. Next, the system includes a progress report module that is operable to provide a learner with information about his or her answers and justifications and an interaction module that is operable to allow a learner to interact with other answers and justifications and with other learners. A learner interface module provides a connection between the learner and the system.

In another embodiment, the present invention provides an authorable, modularized computer-based system that includes a features module that is operable to allow an author to choose the features that will be offered in the system. In addition to the modules mentioned above, the system of this embodiment includes a learner feedback module that is operable to allow the author to select the information that the system will provide to learners concerning the learners' answers and justifications and a data reporting module that is operable to allow the author to determine the information he or she will receive concerning the learners' answers and justifications. This system further includes an author interface that provides a connection between the author and the system.

In yet another embodiment, the present invention includes a method in which an author selects the features a system will employ. Thereafter, the author inputs information and questions. The author also inputs reference material and chooses learner feedback and learner interaction options for those features selected. Next, the author selects progress report and data report options if those features are selected.

The systems and methods of the present invention teach critical thinking skills in a computer-based environment, and particularly in a computer network-based environment, by requiring a learner to provide a justification for his or her answers concerning information provided. Additionally, the systems and methods of the present invention provide reference material for a learner to review before and after answering a question and/or providing a justification and allow a learner to compare his or her answer and justification to those of other learners and experts. In this manner, the learner is efficiently and effectively taught critical thinking skills.

### BRIEF DESCRIPTION OF THE SEVERAL VIEWS OF THE DRAWING

The present invention is described in detail below with reference to the attached drawings figures, wherein:

FIG. 1 is a block diagram illustrating an exemplary computing system environment in which the present invention may be practiced;

FIG. 2 is block diagram illustrating an exemplary network environment in which the present invention may be practiced;

FIG. 3 is a block diagram of a method according to one embodiment of the present invention;

FIG. 4 is a block diagram of an exemplary electronic page according to one embodiment of the present invention;

FIG. 5 is a block diagram of an exemplary electronic page according to one embodiment of the present invention;

FIG. 6 is a block diagram of an exemplary electronic page according to one embodiment of the present invention;

FIG. 7 is a block diagram of an exemplary electronic page according to one embodiment of the present invention;

FIG. 8 is a block diagram of an exemplary electronic page according to one embodiment of the present invention;

FIG. 9 is a block diagram of an exemplary electronic page according to one embodiment of the present invention;

FIG. 10 is a block diagram of a method according to one embodiment of the present invention; and

FIG. 11 is a block diagram of a system according to one embodiment of the present invention.

### DETAILED DESCRIPTION OF THE INVENTION

The present invention provides a system and method for use in a computing environment for teaching critical thinking skills. The systems and methods include providing a learner with information, asking the learner to answer questions regarding the information and then asking the learner to justify his or her answer. The systems and methods then provide the learner with results comparing his or her answers and justifications to other learners and with an expert. The present invention may also provide resource material to the learner to assist in answering questions and developing justifications and to aid in understanding suitable answers and justifications. By using the present invention a learner is taught critical thinking skills in a timely and optimal fashion.

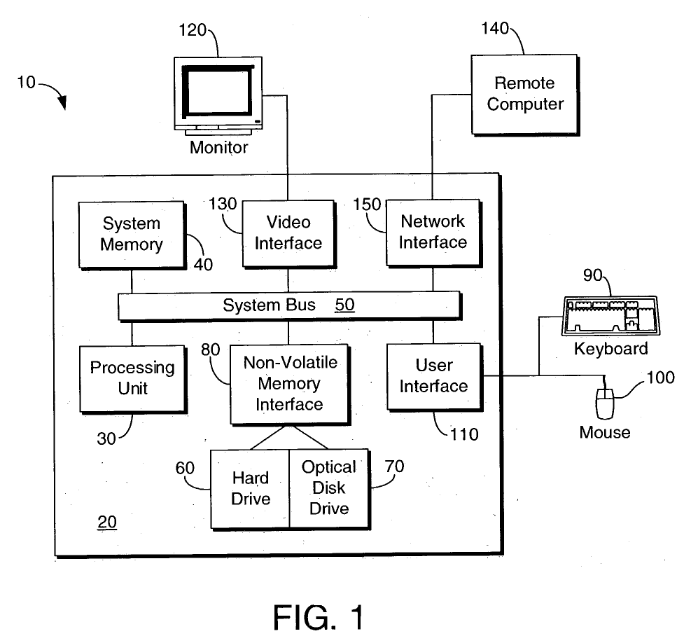

Referring now to FIG. 1, an exemplary computing system environment on which the invention may be implemented is generally denominated by the numeral 10. It should be understood that computing system environment 10 is only one example of a suitable computing environment and is not intended to suggest any limitation as to the scope of the invention. As those skilled in the art will appreciate, the invention may be practiced with other computer system configurations. The invention may also be practiced in distributed computing environments where tasks are performed by remote processing devices that are linked through a communications network.

Computing system environment 10 includes a general purpose computing device in the form of a computer 20 that includes a processing unit 30, a system memory 40, and a system bus 50 that couples various system components including system memory 40 to processing unit 30. Computer 20 typically includes a variety of computer readable media. By way of example, and not limitation, computer readable media may comprise computer storage media and communication media. System memory 40 includes computer storage media in the form of volatile and/or nonvolatile memory such as read only memory (ROM) and random access memory (RAM).

Computer 20 may also include other computer storage media. By way of example only, FIG. 1 illustrates a hard disk drive 60 that reads from or writes to nonremovable, nonvolatile magnetic media and an optical disk drive 70 that reads from or writes to a removable, nonvolatile optical disk such as a CD ROM or other optical media. Hard disk drive 60 and optical disk drive 70 are typically connected to system bus 50 through a non-volatile memory interface such as interface 80. The drives and their associated computer storage media may provide storage for computer readable instructions, data structures, program modules and other data for computer 20.

A user may enter commands and information into computer 20 through input devices such as a keyboard 90 and a mouse 100. (It should be understood that mouse 100 is one example of a pointing device. Other pointing devices include a trackball, a touch pad and a light pen.) These and other input devices are often connected to the processing unit 30 through a user interface 110 that is coupled to system bus 50, but may be connected by other interface and bus structures, such as a parallel port or a universal serial bus (USB). A monitor 120 or other type of display device is also connected to system bus 50 via an interface, such as a video interface 130. In addition to a monitor, computers may also include other peripheral output devices such as speakers and a printer (not shown).

As will be explained further below, in the present invention computer 20 may operate in a networked environment using logical connections to one or more remote computers, such as a remote computer 140. These logical connections may include a local area network (LAN) and/or a wide area network (WAN), and may also include other networks. In addition, it should be understood that portions of these networks can be wired, wireless, or some combination thereof. When used in a networking environment, computer 20 may be connected to the network through a network interface or adapter 150. In addition, computer 20 may include a modem or other means for establishing communications over a network. In a networked environment, program modules or portions thereof may be stored in the remote computer 140.

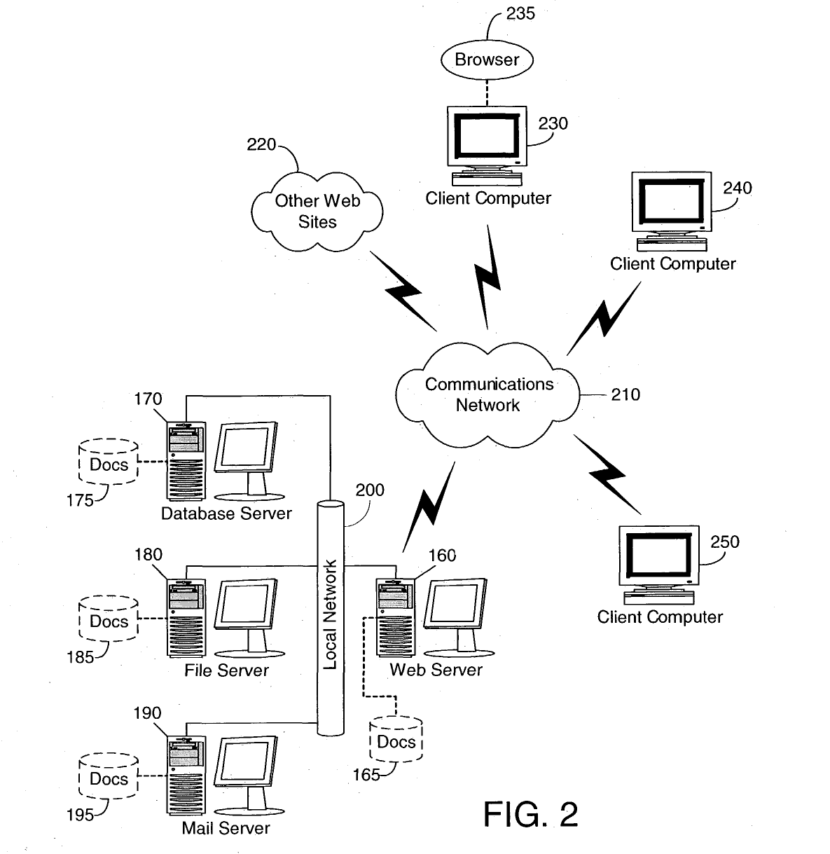

FIG. 2 illustrates an exemplary computer network environment on which the invention may be implemented. It should be understood that the computer network environment shown is only one example of a suitable network environment and is not intended to suggest any limitation as to the scope of the invention. As those skilled in the art will appreciate, the invention may be practiced with other network configurations.

As shown in FIG. 2, web server 160 is interconnected to a number of other server computers, such as a database server 170, a file server 180 and a mail server 190. Web server 160 includes a document storage device 165. Similarly, database server 170, file server 180 and mail server 190 include document storage devices 175, 185 and 195 respectively. In this example, web server 160, database server 170, file server 180 and mail server 190 are part of a local area network 200. A wide area communications network 210 (e.g. the Internet) permits remote Web sites 220 and client computers 230, 240 and 250 (each equipped with a browser such as browser 235) to gain access to web server 160, for example to search for documents or other forms of electronically stored information.

Generally, a client computer, such as computer 230, includes a browser function or separate browser application 235 that may locate and display documents to a user. When a user at client computer 230 desires to see a document, browser 235 causes client computer 230 to issue a request that includes the URL (Uniform Resource Locator) value for the document sought in an HTTP (Hypertext Transfer Protocol)-coded command. A URL value is a unique address which fully specifies the location of a content object on the Internet. HTTP is the standard World Wide Web client-server protocol used for the exchange of information (such as HTML documents, and client requests for such documents) between a Web browser and a Web server. HTTP includes several different types of messages that can be sent from the client to the server to request different types of server actions.

After receiving such a request, Web server 160 will either obtain the HTML (HyperText Markup Language) page, for example from file server 180, or assemble the HTML page from an HTML file. HTML is a standard coding convention and set of codes for attaching presentation and linking attributes to informational content within documents. During a document authoring stage, the HTML codes are embedded within the informational content of the document. When the Web document is subsequently transmitted by a Web server to a Web browser, the codes are interpreted by the browser and used to parse and display the document or page. An HTML document is a special type of document which includes HTML codes to permit the document to be viewed using a Web browser program. An HTML document that is accessible on a World Wide Web site is commonly referred to as a “Web document” or “Web page.”

If the HTML page is assembled, Web server 160 will process the information stored in the HTML file, extract any queries from the file and issue those queries, for example to database server 170. Database server 170, in turn, may issue queries to file server 180 or some other computer. Web server 160 will receive the results of these queries and merge that information with the contents of the HTML file to generate an HTML page. The HTML page is then routed via communications network 210 to client computer 230 where browser 235 operates to display the page. The operation of Web browsers, the Internet, the World Wide Web and HTML authoring systems are well-known in the art.

As stated above, the present invention may be embodied as a method or a system implemented in a computing environment. Thus, when implemented, the present invention will be composed of computer-executable instructions, such as HTML instructions, that may be grouped together in program modules. Generally, a program module will include programs, objects, components, data structures, etc. that perform particular tasks or implement particular abstract data types. In a distributed computing environment or a computer network environment, program modules may be located in one or more local and/or remote computer storage media including memory storage devices. Additionally, if the method is implemented on a server, such as, for example, web server 160, then the learner may be present at a remote computer, such as client computer 230, and may access the server over a communications network, such as the Internet.

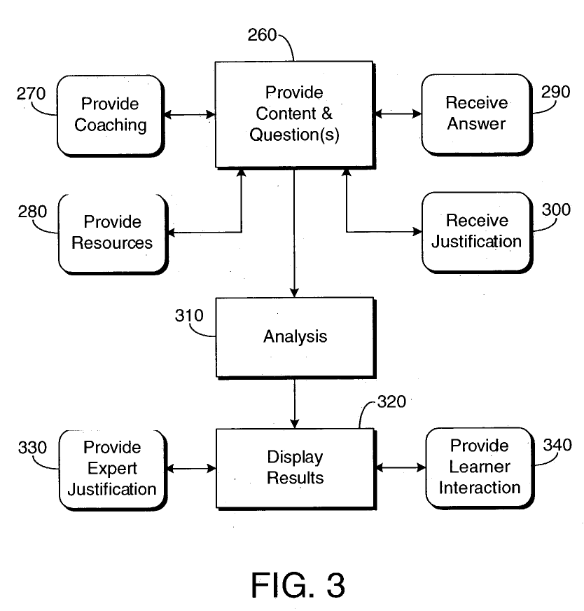

Referring now to FIG. 3, in one embodiment the present invention is a method implemented in a computing environment. According to this embodiment of the present invention, the method begins in box 260 where informational content and a question or questions are presented to a learner. The content may be in any format available for use with a computer including, but not limited to, text, pictures, video, audio, or any combination thereof. The content and question may be presented in the form of an electronic page or document, such as a Web page, that is capable of being displayed by, for example, a browser function or application.

From box 260 the learner may request assistance in the form of a “coach” and thereby move to box 270. It should be understood that in some embodiments, “coaching” may be mandatory and, therefore, the method will move to box 270 when, not if, the learner selects the coach. In box 270, “coaching” is provided to the learner. Coaching includes providing information in the form of text, audio and or video in advance of or in conjunction with a learner answering a question and/or providing a justification in order to assist the learner in making an informed decision and forming higher-level rationales. After providing the coaching, the method returns to box 260.

From box 260 the learner may request additional reference or resource material related to the subject matter at issue and thereby move to box 280. In box 280, resources that the learner may utilize, for example, to understand the question presented in box 260 are provided to the learner. The resources may include, but are not limited to, titles, excerpts or summaries of books or articles that the learner may obtain or links to pertinent Web pages. After providing the resource material, the method returns to box 260.

After reviewing the content and question, the learner must provide an answer to the question and a justification for his or her answer. When the learner provides an answer, the method moves to box 290 where the answer is received and stored. When the learner provides a justification, the method moves to box 300 where the justification is received and stored. After receiving an answer or a justification, the method returns to box 260. When ready to proceed, the learner will submit his or her answer and justification, and the method will move to box 310.

In box 310, an analysis is performed. This analysis may include, for example, entering the learner's answer and justification for the particular question into the population of all learner answers and justifications for that question and then determining the average answer, the distribution of answers, or other statistical measures. The analysis may also include forming visual aids such as a bar graph or pie chart that illustrates the distribution of the answers.

Once the analysis is performed, the method continues in box 320 where results are displayed for the learner. The results may include, for example, the visual aids formed in box 310. The results may also include other learner's actual answers and justifications.

At box 320, the learner may request an expert judgment and thereby move the method to box 330. At box 330, an expert judgment is provided the learner for his or her review. This judgment is much like the coaching discussed previously in that it may be in the form of text, audio or video. Unlike the coaching information, however, the expert judgment provides specific information about an answer and justification provided by an expert in the field. Following the learner's review of the expert judgment, the method returns to box 320.

Finally, at box 320, the learner may elect to interact with other learners and/or the other learners' answers and justifications and thereby move the method to box 340. At box 340, the learner interacts with other learners and/or their answers and justification. This interaction may include, but is not limited to, reading other answers and justifications, ranking the justifications, rating the best justification, and e-mailing a comment about a justification to another learner.

To further illustrate the method discussed above, the following example is provided. It should be understood that this example is provided for illustrative purposes only and is not intended to limit the scope of this invention. In the example, the present invention is utilized to instruct learners about the qualities teachers consider in student writing and to develop the learner's ability to assess student writing. The critical thinking aspect of this example is the development of the learner's ability to assess student writing. Learners in this example may include, for example, actual teachers and student-teachers.

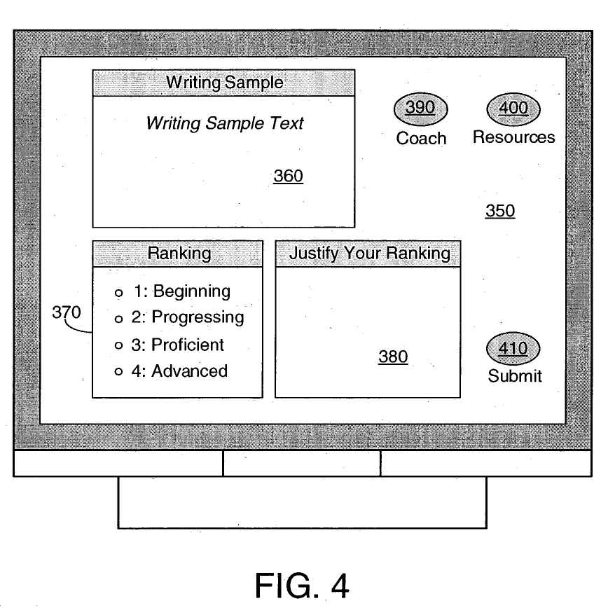

Referring first to FIG. 4, the invention initially provides the learner with an electronic page 350 containing a student writing sample 360 and a question 370 that asks the learner to provide a numerical rank for the writing sample based on certain criteria, such as sentence structure or word choice. The page may present writing sample 360 as a typed document or as a “snapshot” of the original paper, which would show the writing in the student's handwriting. Page 350 may also contain additional information that explains each rank in terms of the criteria. As shown in FIG. 4, for example, a rank of 1 is indicative of a beginner while a rank of 4 is indicative of an advanced writer. The additional information could provide that a beginner is a writer that is “not yet showing control” and that an advanced writer “exceeds expectations.” Page 350 also contains an area 380 for entering a justification, a coach button 390, a resources button 400 and a submit button 410.

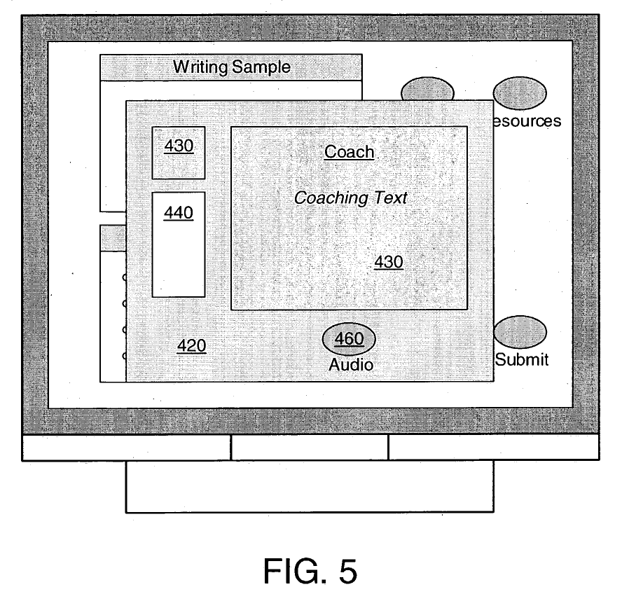

Referring now to FIG. 5, if the learner selects coach button 390 on page 350, the invention provides page 420 containing a picture 430 of an experienced teacher, a brief biography of the teacher 440 to establish the teacher's credibility, and a quote 450 from the teacher that offers more detail about the criteria in question and the rankings. The learner may read the quote or select audio button 460 to listen to a recording of the quote. Closing page 420 returns the learner to page 350 in FIG. 4.

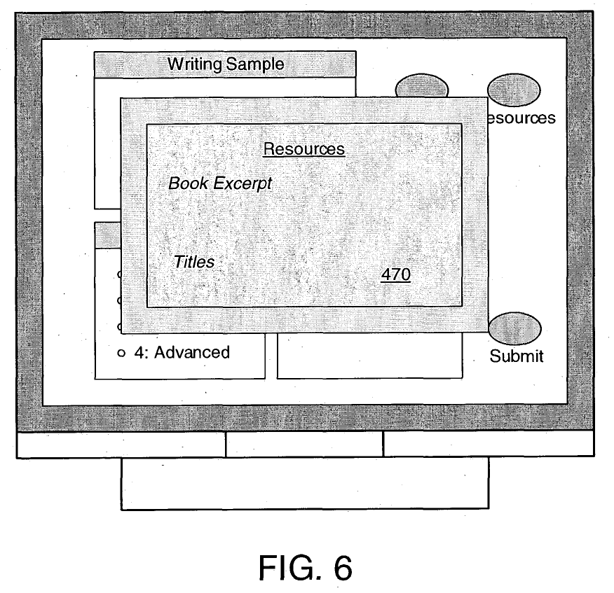

Referring now to FIG. 6, if the learner selects resources button 400 on page 350, the invention provides page 470 which contains an excerpt from a teacher handbook and titles for other scholastic references the learner may obtain to learn more about the criteria. Closing page 470 returns the learner to page 350 in FIG. 4.

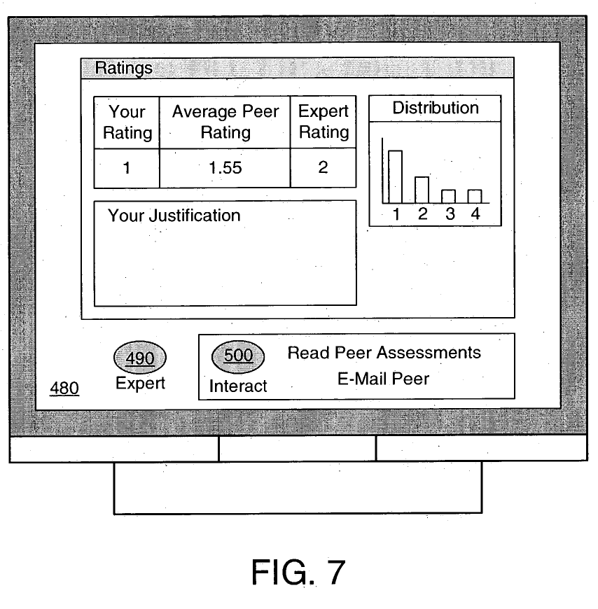

After the learner enters a rank and a justification and selects submit button 410 on page 350, the invention saves the responses in a database and calculates the average ranking among all saved rankings in the database for the particular question and prepares a bar graph showing the distribution of the rankings. The invention then provides electronic page 480, as shown in FIG. 7, with the average ranking, the distribution bar graph, and an expert ranking along with the learner's ranking and justification. This page also contains an expert button 490 and an interaction button 500.

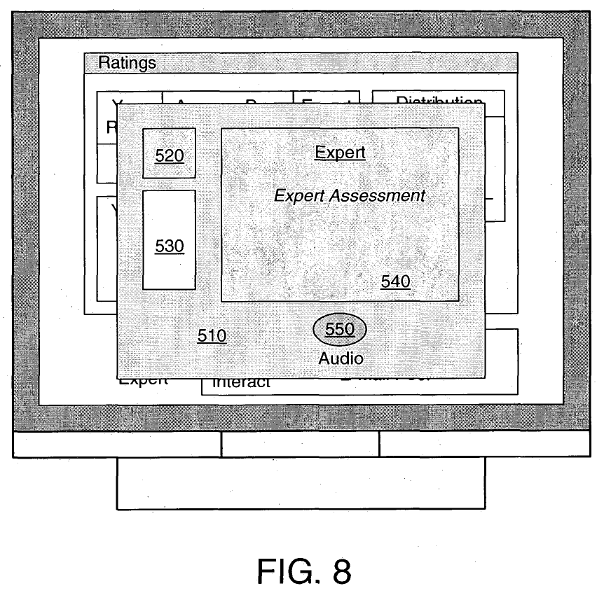

Referring now to FIG. 8, if the learner selects expert button 490 on page 480, the invention provides electronic page 510 containing a picture 520 of an experienced teacher, a short biography 530 of the expert, and a quote 540 from that teacher that states the expert's ranking and justification. The learner may read the quote or select audio button 550 to listen to a recording of the quote. Closing page 510 returns the learner to page 480 in FIG. 7.

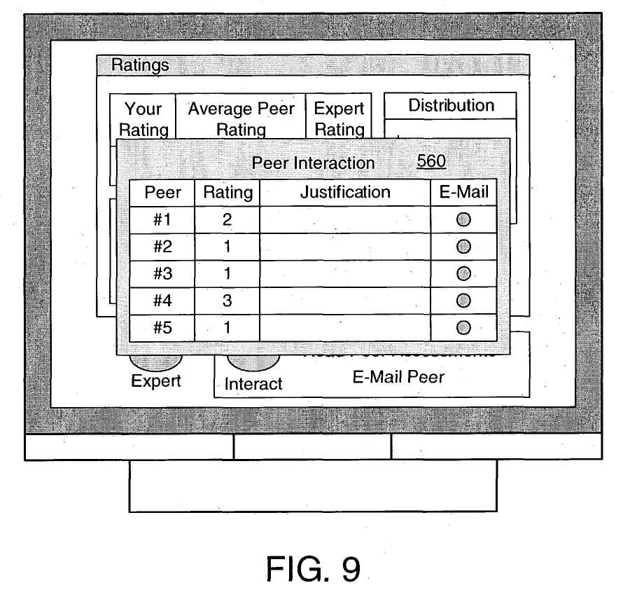

Referring now to FIG. 9, if the learner selects interaction button 500 on page 480, the invention provides page 560 containing other learners' rankings and justifications for the learner to read and an area to enter an e-mail comment about a particular justification. Closing page 560 returns the learner to page 480 in FIG. 7.

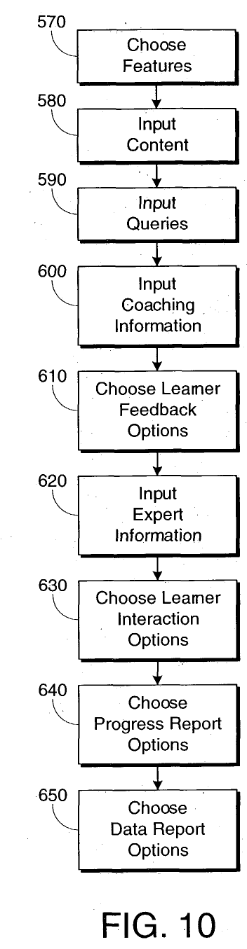

In FIG. 10, in yet another embodiment, the present invention is a method in which an author is able to create a customized version of the invention. The method begins at box 570 when an author selects or chooses the features a system will employ. In this step, for example, the author will decide whether to provide a coach function or a resource function and whether to make consultation of these functions mandatory. It should be understood that if the author chooses to omit a particular function, then the method will skip the box addressing that function.

The method then continues at box 580 where the author inputs the informational content. As indicated above, the informational content may be in the form of text, audio, video or some combination thereof. Next, at box 590, the author inputs the queries that are tied to the informational content.

At box 600, the author will input the coaching information. In the example above, “coaching information” included a photograph, a biography and a quote. It should be understood that “coaching information” is not limited to these types of information.

At box 610, the author chooses the learner feedback options, or those parts of the learner's responses that will be displayed. For example, the author may choose to allow the learner to view only his or her own answer and justification or the author may elect to allow the learner to view graphical and/or numerical feedback on group performance and a running average of the learner's ratings along with a discrepancy score for their rating and the expert's ratings.

At box 620, the author inputs the expert information. As with the coaching information and the informational content, the expert information may be in any computer readable format. It should also be noted that “expert” answers and justifications also may be seeded into the learner answer and justification storage so that when a learner reviews other learner assessments (assuming the author has authorized this conduct) he or she will also review the expert assessments.

At box 630, the author chooses the learner interaction options. For example, the author may allow the learners to review their peers answers and justifications, rate their peers answers and justifications and e-mail comments to other learners. Additional types of interaction may also be chosen if supported by the computing environment such as, for example, entering into a real-time dialog with other learners currently using the customized system or monitoring a dialog between other users, which may include experts.

In box 640, the author chooses the progress report options. In this step, the author determines the measures of knowledge, motivation and interest that will be made available to learners, such as measures of self-efficacy and/or queries of learner likes and learning during their work within the application, and how progress will be reported to learners (e.g. by scoring and reporting test scores immediately or by reporting progress through a site map).

In box 650, the author chooses the data reports that will be made available to the author and/or researchers. For example, the author may elect to generate reports concerning learner demographics, or concerning site performance (which may include timing—how long between content presentation and submission of assessment?—and choice information), or concerning measures of learning and motivational outcomes. Additional possibilities for data reporting include, but are not limited to, number of cycles per learner, number of uses of the Coach or Expert feature, and correlations between use of the Coach feature and discrepancy between the learner and Expert assessment.

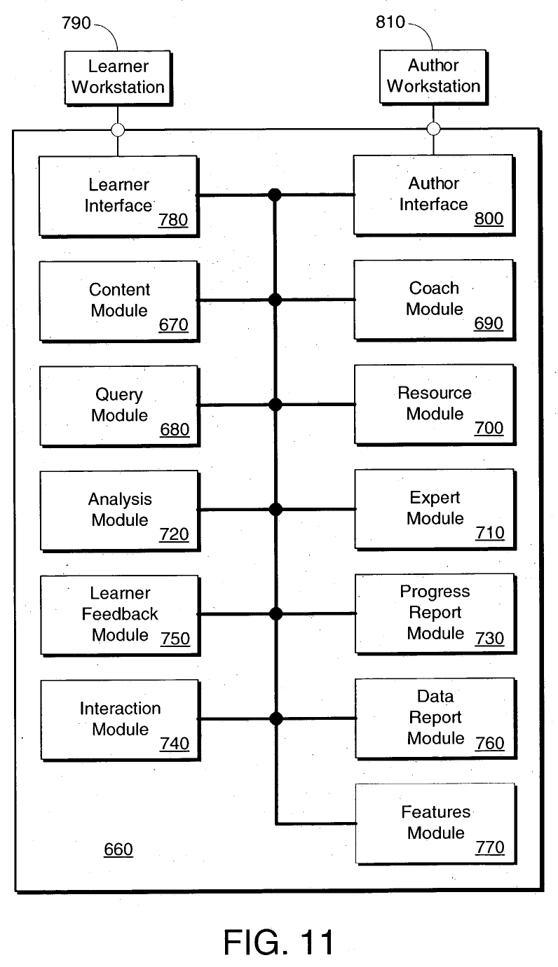

Continuing on to FIG. 11, in another embodiment, the present invention provides an authorable, modularized computer-based system generally referred to by the numeral 660. Initially, system 660 includes a content module 670 and a query module 680 that are operable to receive and store informational content and questions respectively and to provide the information and questions to learners. In addition, query module 680 is operable to receive and store learner answers and justifications. System 660 also includes a coach module 690, a resource module 700 and an expert module 710 that are operable to store reference material and to provide that material to learners. It should be understood that, in addition to a custom-written computer program, many commercial database applications may serve as content module 670, query module 680, coach module 690, a resource module 700 and an expert module 710.

System 660 includes an analysis module 720 that is operable to perform statistical analysis on information, such as learner ratings associated with particular questions, and provide results, such as charts and graphs. As with the modules discussed above, it should be understood that many commercial applications, such as a spreadsheet application, may serve as analysis module 720.

Continuing with FIG. 11, system 660 includes a progress report module 730 that is operable to provide a learner with information about his or her answers and justifications and an interaction module 740 that is operable to allow a learner to interact with other answers and justifications and with other learners. Next, system 660 includes a learner feedback module 750 that is operable to allow the author to select the information that the system will provide to learners concerning the learners' answers and justifications, a data reporting module 760 that is operable to allow the author to determine the information he or she will receive concerning the learners' answers and justifications and a features module 770 that is operable to allow an author to choose the features that will be offered in the system as discussed above.

Finally, system 660 includes a learner interface module 780, which provides a connection between a learner workstation 790 and system 660, and an author interface 800, which provides a connection between an author workstation 810 and system 660. Interfaces 780 and 800 may be graphical user interfaces.

From the foregoing it will be seen that this invention is one well adapted to attain all the ends and objects set for above, together with other advantages, which are obvious and inherent to the system and method. It will be understood that certain features and sub-combinations are of utility and may be employed without reference to other features and sub-combinations. This is contemplated and within the scope of the appended claims. Moreover, while particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

What is claimed is:

1. A method in a computing environment for teaching critical thinking skills, said method comprising:
providing informational content relating to a subject matter and a question concerning said informational content to a learner;
receiving from said learner an answer to said question and a justification for said answer;
conducting an analysis involving said answer, said analysis providing at least one result;
providing said at least one result to said learner; and
providing the answer and justification of an expert in the field of said subject matter to said learner.

2. The method of claim 1 further comprising providing reference material to said learner, said reference material designed to assist said learner in forming said answer and said justification.

3. The method of claim 2 wherein providing reference material includes providing an explanation of criteria applicable to forming said answer to said question.

4. The method of claim 2 wherein said reference material includes an electronic link to a Web site containing background information concerning said subject matter.

5. The method of claim 1 further comprising storing said answer and said justification on a computer storage media.

6. The method of claim 5 wherein said storing is accomplished by saving said answer and said justification in a database.

7. The method of claim 1 wherein said informational content and said question are presented as part of a first electronic page and said at least one result is presented as part of a second electronic page.

8. The method of claim 1 wherein said analysis is a statistical analysis.

9. The method of claim 8 wherein said at least one result includes the distribution of all learner answers to said question.

10. The method of claim 8 wherein said at least one result includes the average of all learner answers to said question.

11. The method of claim 1 further comprising allowing said learner to interact with the answers and justification of other learners for said question.

12. The method of claim 11 wherein said interaction includes displaying the answers and justification of other learners for said question.

13. The method of claim 11 wherein said interaction includes receiving a comment from said learner relating to another learner's justification and sending said comment to said other learner.

14. The method of claim 13 wherein said comment is sent by e-mail.

15. The method of claim 1 further comprising receiving and storing said informational content, said question, and said expert answer and justification.

16. The method of claim 15 wherein said informational content, said question and said expert answer and justification are stored in a database.

17. A computer readable medium having computer-executable instructions for performing the method recited in claim 1.

18. A system in a computer environment for teaching critical thinking skills to a learner, said system comprising:
a content module operable to receive and store informational content and to provide said content to said learner;
a query module operable to receive and store questions and to provide said questions to said learner, and further operable to receive and store said learner's answers to said questions and said learner's justification for said answers;
an analysis module operable to analyze learner answers and justifications in order to form at least one result and to provide said at least one result to said learner;
an expert module operable to receive and store an expert's answers and justifications and to provide said expert answers and justifications to said learner; and
a learner interface module operable to provide a connection between said learner and said system.

19. The system of claim 18 further comprising a reference module operable to receive and store reference material and to provide said reference material to said learner.

20. The system of claim 18 further comprising an interaction module operable to allow said learner to interact with other learners' answers and justifications.

21. The system of claim 20 wherein said interaction module is operable to display all learners' answers to said question and the justifications for these answers.

22. The system of claim 20 wherein said interaction module is operable to email a comment from said learner to another learner.

23. The system of claim 18 further comprising a progress report module operable to provide said learner with information indicative of said learner's progress through said informational content and said questions.

24. The system of. Claim 18 further including an author interface operable to provide a connection between an author and said system.

25. The system of claim 24 further comprising a features module operable to receive feature selections from said author and to store said selections.

26. The system of claim 24 further comprising a learner feedback module operable to allow the author to select the information that the system will provide to said learner concerning said learner's answers and justifications.

27. The system of claim 24 further comprising a data reporting module that is operable to allow the author to determine the information he or she will receive concerning the learners' answers and justifications.

28. The system of claim 18 wherein said content, query and expert module store information in a database.

29. The system of claim 18 wherein said analysis module is a spreadsheet application.

30. The system of claim 18 wherein said analysis module is operable to perform statistical analysis.

31. The system of claim 18 wherein said content module provides said informational content and said query module provides said question as part of a first electronic page and said analysis module provides said at least one result as part of a second electronic page.

32. The system of claim 18 wherein at least one of said modules contains HTML instructions.

33. A computer program product comprising:
a computer readable medium containing computer readable code thereon for teaching critical thinking skills to a learner, said computer readable code comprising:
computer readable code devices configured to cause a computer to transmit informational content and a question associated with said informational content over a communications network to a client computer;
computer readable code devices configured to cause a computer to receive and store an answer and a justification over a communications network from said client computer;
computer readable code devices configured to cause a computer to perform an analysis of said stored answers and justifications and provide a result;
computer readable code devices configured to cause a computer to transmit said result over a communications network to said client computer; and
computer readable code devices configured to cause a computer to transmit an expert answer and justification over a communications network to said client computer.

34. The computer program product of claim 33 wherein said computer readable code further includes computer readable code devices for receiving a resource selection over said communication network from said client computer and for transmitting resource information over said communications network to said client computer.

35. The computer program product of claim 33 wherein said computer readable code further includes computer readable code devices for receiving an interaction selection over said communications network from said client computer and for transmitting the answers and justifications of all learners over said communications network to said client computer.

36. The computer program product of claim 35 wherein said computer readable code further includes computer readable code devices for receiving a comment about another learner's answer and justification over said communications network from said client computer and for transmitting said comment to an e-mail account associated with said other learner.

37. The computer program product of claim 33 wherein said computer readable code further includes computer readable code devices for receiving and storing information content, questions and expert answers and justifications.

38. The computer program product of claim 33 wherein said informational content and said question are transmitted as part of a first electronic page and said result is transmitted as part of a second electronic page.

39. The computer program product of claim 38 wherein said expert answer and justification is transmitted as part of said second electronic page.

40. The computer program product of claim 33 wherein said computer readable code further includes computer readable code devices for obtaining date relating to site usage, learner characteristics, site performance, or learner motivation and transmitting said data to a second client computer.
